(19) United States
(12) Patent Application Publication
(10) Pub. No.: US 2014/0244650 A1
(43) Pub. Date: Aug. 28, 2014

(54) DISTRIBUTED EVENT PROCESSING

(71) Applicants: Yizheng Zhou, Cupertino, CA (US); Wei Huang, Fremont, CA (US); Michael Scott Weston, La Honda, CA (US); Hector Aguilar-Macias, Sunnyvale, CA (US); David Earl Wiser, Eugene, OR (US)

(72) Inventors: Yizheng Zhou, Cupertino, CA (US); Wei Huang, Fremont, CA (US); Michael Scott Weston, La Honda, CA (US); Hector Aguilar-Macias, Sunnyvale, CA (US); David Earl Wiser, Eugene, OR (US)

(21) Appl. No.: 14/352,121

(22) PCT Filed: Dec. 20, 2011
(86) PCT No.: PCT/US2011/066060

§ 371 Date: Apr. 16, 2014

Related U.S. Application Data
(60) Provisional application No. 61/555,548, filed on Nov. 4, 2011.

(51) Int. Cl. G06F 17/30

(52) U.S. Cl. CPC G06F 17/30598; G06F 17/30336
USPC 707/737

(57) ABSTRACT

A distributed event processing method includes providing a plurality of connectors. Each provided connector is configured to acquire event data from an assigned data source, partition acquired event data into clusters, and divide each cluster into chunks. The method also includes collecting the chunks from the plurality of connectors and storing the chunks to a data file that can be queried.

### BACKGROUND

Event management systems operate by collecting data from multiple sources and storing the collected data centrally so that it may be analyzed for a particular purpose or purposes. In some cases the data can include millions or even billions of records. For example, a security information/event management system functions to 1) collect data from networks and networked devices that reflects network activity and/or operation of the devices and 2) analyze the data to enhance security. The data can be analyzed to identify an attack on the network or a networked device and determine which user or machine is responsible. If the attack is ongoing, a countermeasure can be performed to thwart the attack or mitigate the damage caused by the attack. The data that is collected many times originates in a message (such as an event, alert, or alarm) or an entry in a log file, which is generated by a networked device. Example network devices include firewalls, intrusion detection systems, and servers.

### DRAWINGS

FIG. 1 depicts an environment in which various embodiments may be implemented.

FIG. 2 depicts a system according to an example.

FIG. 3 is a block diagram depicting a memory and a processor according to an example.

FIG. 4 is a flow diagram depicting steps taken to implement an example.

FIG. 5 is communication sequence diagram according to an example.

### DETAILED DESCRIPTION

### Introduction

Event management systems collect, process, and store event records from a variety of sources. Such processing can include normalizing, partitioning, indexing, and compression. The records for a given system can be collected from a multitude of devices and can number into the billions. Centrally processing records collected from multiple sources can consume significant communication bandwidth and processor resources. Various embodiments described below operate distribute the processing functions across a number of agents referred to as connectors to reduce the demand on any given processor. Further, the connectors, when processing the records, can add a level of compression reducing communication bandwidth consumed when delivering the records for central storage.

In an example implementation, a plurality of connectors are provided. Each connector is configured to acquire event data from an assigned data source and partition acquired event data into clusters. Each cluster can include rows of event data segmented into columns of event fields. The connectors are responsible for dividing the partitions into chunks. Such chunks may be compressed. A chunk is a selected portion of a partition. In an example, a chunk includes the fields of a given cluster column. The chunks are collected from the plurality of connectors and stored to a data file that can be queried. It is noted that the chunks from various connectors may be merged or otherwise coalesced prior to being stored. By storing chunks representing columns of partitions, the data file is read optimized. In an example, each connector assembles metadata for each chunk. That metadata may be included or otherwise linked to each chunk. When the chunks are collected, merged and stored, that metadata is used to maintain an index for the data file. Where the metadata for each chunk identifies that chunk, the resulting index allows the individual chunks to be accessed and returned from the data file in response to a query.

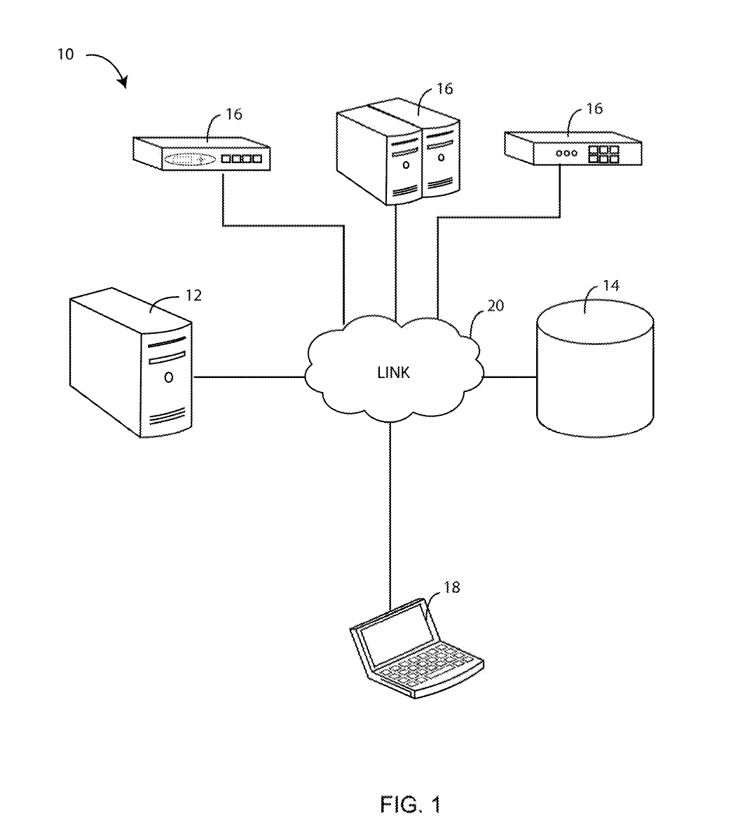

FIG. 1 depicts an environment 10 in which various embodiments may be implemented. Environment 10 is shown to include event management device 12, data store 14, network data sources 16, and client device 18, Event management device 12 represents generally any computing device or combination of computing devices configured to collect and store event data generated by network data sources 16. Event management device 12 stores the event data in data store 14 and is responsible for responding to queries from client device 18 by returning selected portions of the stored data satisfying a given query.

Each network data sources 16 represent generally a device or an application running on a device that is configured to provide event data. Event data is data describing an event and may be captured in logs or messages generated by a given data source 16. As an example, intrusion detection systems (IDSs), intrusion prevention systems (IPSs), vulnerability assessment tools, firewalls, anti-virus tools, anti-spam tools, and encryption tools may generate logs describing activities performed by a data source 16. Event data may be provided, for example, by entries in a log file or a syslog server, alerts, alarms, network packets, emails, or notification pages.

In the example of FIG. 1, data sources 16 are depicted as an intrusion detection device, a server, and a firewall. More generally, a data source 16 is a network node, which can be a network device or a software application. As examples, other types of data sources can include intrusion prevention systems, vulnerability assessment tools, anti-virus tools, anti-spam tools, encryption tools, application audit logs, and physical security logs.

Link 20 represents generally one or more of a cable, wireless, fiber optic, or remote connections via a telecommunication link, an infrared link, a radio frequency link, or any other connectors or systems that provide electronic communication. Link 20 may include, at least in part, an intranet, the Internet or a combination of both. Link 20 may also include intermediate proxies, routers, switches, load balancers, and the like.

The following description is broken into sections. The first, labeled “Components,” describes examples of various physical and logical components for implementing various embodiments. The second section, labeled as “Operation,” describes steps taken to implement various embodiments.

### Components

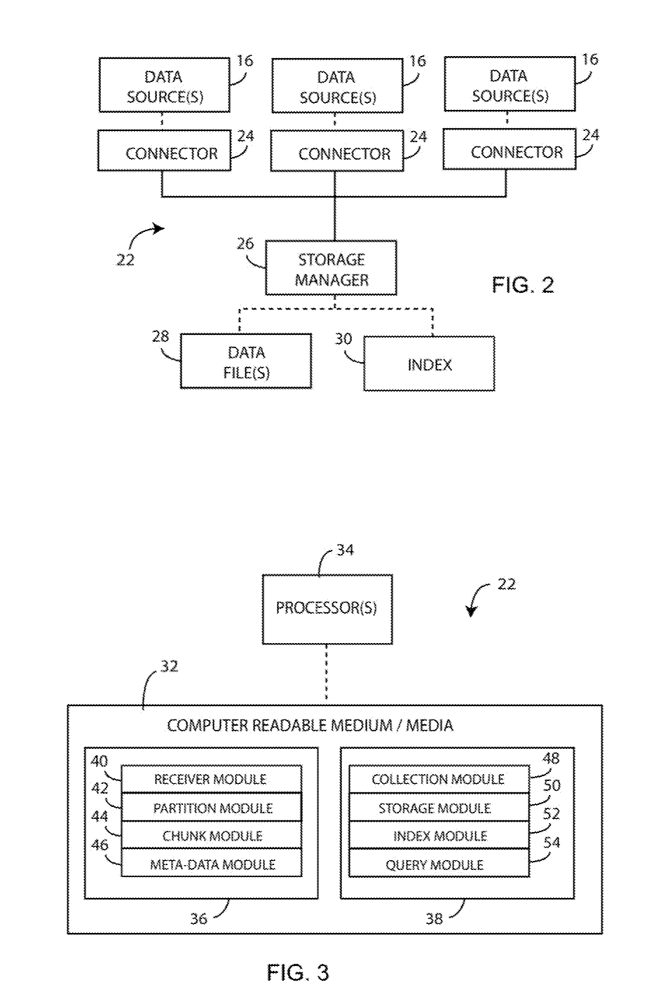

FIGS. 2-3 depict examples of physical and logical components for implementing various embodiments. FIG. 2 depicts a distributed event processing system 22. In the example of FIG. 2, system includes connectors 24, and storage manager 26. FIG. 2 also depicts data sources 16 in communication with connectors 24 and depicts data file 28 and index 30 as accessible to storage manager 26.

Each connector 24 represents generally any combination of hardware and programming configured to acquire event data from an assigned one of data sources 16, partition the acquired event data into clusters, and divide each cluster into chunks. While three connectors 24 are shown, system 22 may include any number of connectors 24. The assignment of a given connector 24 to a given data source or sources 16 reflects that the particular connector 24 is configured to process event data of a format collected from that data source or sources 16. A given connector 24 may be implemented as an integrated component of its assigned data source 16. A connector 24 may be implemented by a separate network device such as an application server. Yet other connectors 24 may be integrated with storage manager 26.

As discussed above, event data can take multiple forms such as entries in a log file or a syslog server, alerts, alarms, network packets, emails, or notification pages. A given connector 24 may acquire event data by actively retrieving the event data from its assigned data source 16 or it may passively receive the event data. The event data, for a given connector 24, can be acquired in event batches over time. The acquired event data is partitioned into clusters. In an example, a given cluster of event data may correspond to a batch. In other examples a cluster may contain multiple batches or may be a portion of a batch of event data received from the assigned data source 16.

The event data, if needed, can be normalized by connectors 24 to a predetermined schema such that each event represented in the event data corresponds to a row with various attributes of the event appearing in fields of that row. Thus, an event data cluster can then be represented as a table with attributes of a given type appearing in the same column. In other words, each cluster includes rows of event data segmented into columns of event fields. Each event field contains data representing an attribute of that event. For each such cluster, a corresponding connector 24 divides the cluster into chunks where each chunk represents a column of event fields in that cluster.

Each connector 24 may acquire, generate, or otherwise maintain metadata for each the event data. In particular, such metadata may be included in or otherwise linked to each chunk. Metadata, for example, can identify its associated chunk as well as information relevant to the event attributes contained in that chunk. Such information may relate to the attribute type and specific attribute values and more broadly to characteristics of the events from which the chunks were divided. Such broader information may identify a time the event was generated at a corresponding data source 16 as well as a time the event was received at the corresponding connector 24. With respect to a given chunk, its associated metadata may identify a time window with respect to which its corresponding events were generated at source 16 or received at connector 24.

Storage manager 26 represents generally any combination of hardware and programming configured to collect chunks from connectors 24 and store the collected chunks to one or more data tiles 28. The chunks may be stored as is or merged or otherwise coalesced and then stored. In addition to collecting the chunks, storage manager 26 may be tasked with collecting metadata for the chunks from connectors 24 and maintaining an index using the collected metadata. As noted, the metadata includes information relevant to the collected chunks and their contents. Thus, index 30 serves as an index to data file 28. Storage manager 26 may then also be responsible for processing queries using index 30 to identify and return event data from data file 28 satisfying the query. Where the metadata includes data identifying individual chunks, index 30 can be used to identify specific chunk or chunks in data file 28 and return that chunk or a portion of its contents that satisfy a given query.

In foregoing discussion, connectors 24 and storage manager 26 were described as combinations of hardware and programming. Such components may be implemented in a number of fashions. Looking at FIG. 3, the programming may be processor executable instructions stored on tangible, non-transitory computer readable media or medium 32 and the hardware may include a processor or processors 34 for executing those instructions. Medium 32 can be said to store program instructions that when executed by processor 34 implement system 22 of FIG. 2. Medium 32 may be integrated in the same device as processor 34 or it may be separate but accessible to that device and processor 68.

In one example, the program instructions can be part of an installation package that when installed can be executed by processor 34 to implement system 22. In this case, medium 32 may be a portable medium such as a CD, DVD, or flash drive or a memory maintained by a server from which the installation package can be downloaded and installed. In another example, the program instructions may be part of an application or applications already installed. Here, medium 32 can include integrated memory such as a hard drive, solid state drive, or the like.

In FIG. 3, the executable program instructions stored in medium 32 are divided into groups 36 and 38. Group 36 includes modules 40-46 that when executed by processor 34 implement a given connector 24 (FIG. 2). Group 38 includes modules 48-54 that when executed implement storage manager 26 (FIG. 2). It is noted that groups 36 and 38 and their respective modules 40-54 may be found on one medium 32 or distributed across multiple media 32.

Referring to group 36, receiver module represents program instructions for acquiring event data from an assigned data source. Partition module 42 represents program instructions for partitioning event acquired event data into dusters. Such can include normalizing the event data to a common schema such that each duster can be represented by a table where each row corresponds to an event and each column corresponds to an event attribute. Chunk Module 44 represents program instructions for dividing clusters into chunks. Metadata module 46 represents program instructions for assembling, identifying, or otherwise maintaining metadata for each chunk The metadata may be included in or otherwise linked to corresponding chunks.

Referring to group 38, collection module 48 represents program instruction for obtaining chunks from connectors 24. Collection module 48 may also receive metadata for the chunks if supplied separately. Storage module 50 represents program instructions for writing the collected chunks to a data file. Prior to writing, storage module 50 may coalesce the chunks. Index module 52 represents program instructions for using metadata collected from a connector to maintain an index that can be used to search a data file to which the corresponding chunks have been written. Query module 54 represents program instructions for using the index to identify a chunk or chunks in the data file that satisfy a query and to return such a chunk or a portion of the chunks contents.

### Operation

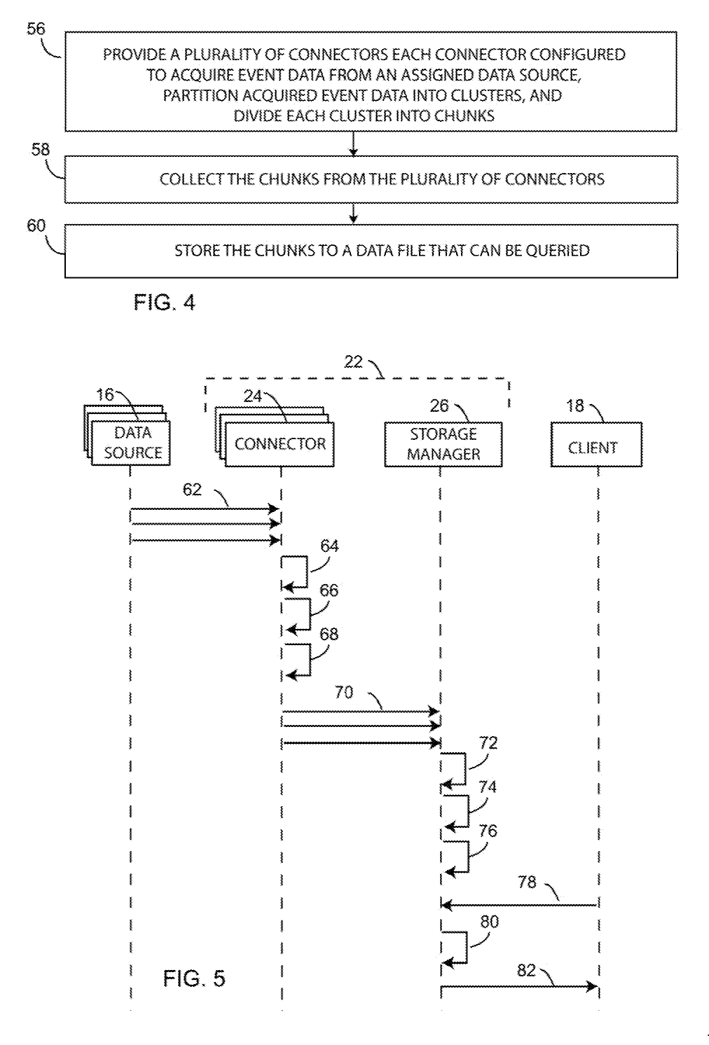

FIG. 4 is a flow diagram of steps taken to implement a distributed event processing method. In discussing FIG. 4, reference may be made to the diagrams of FIGS. 1-3 to provide contextual examples. Implementation, however, is not limited to those examples. In step 56, a plurality of connectors are provided. Each connector is configured to acquire event data from an assigned data source, partition the assigned data into clusters, and divide each cluster into chunks.

Providing in step 56 can be accomplished in a number of fashions. For example, program instructions such as modules 40-46 of FIG. 3 may be installed or otherwise stored to a computer readable medium such that they can be executed by a processor to implement a connector. Providing can include the writing of the program instructions to the computer readable medium. Providing can include a processor or processors executing the program instructions to implement the connectors. Providing can also be accomplished by providing or maintaining a system of devices that include computer readable media storing the program instructions along with processors for executing the instruction to implement the plurality of connectors.

The connectors provided in step 56 may each be configured to partition the acquired event data into clusters such that each cluster includes rows of event data segmented into columns of event fields. Each provided connector may then divide each cluster into chunks where each chunk includes the event fields of a particular column of that cluster. In dividing a partition, a connector may be responsible for dividing the cluster into compressed chunks such that the chunks consume less bandwidth for transmission over a network and less memory when stored. The connectors provided in step 56 may each be configured to divide each cluster into chunks where each chunk is associated with metadata identifying that chunk and an attribute of the chunk. That associated metadata may be included in or otherwise linked to its corresponding chunk.

Chunks are collected from the plurality of connectors (step 58) and stored to a data file that can be queried (step 60). Referring to FIG. 2, steps 58 and 60 may be accomplished by storage manager 26. Storing can include writing the chunks to the data file. It can also include merging or otherwise coalescing the chunks prior to writing to the data file. Where the chunks are associated with metadata, step 60 can include collecting the chunks and the associated metadata. That metadata can then be used to maintain an index for the data file. Referring to FIG. 2, storage manager 26 may receive a query and utilize index 30 to identify specific chunks that contain data that satisfies the query. Those chunks, or potions thereof, can be returned in response to the query.

FIG. 5 is a communication sequence diagram of actions taken with respect to system 22 of FIG. 2 in environment 10 of FIG. 1. More specifically, FIG. 5 depicts steps taken by the components of system 22 within environment 10 to process event data in a distributed fashion within environment 10. Connectors 24 acquire event data from data sources 16 (step 62). As noted above, the event data may be acquired in batches and normalized to a common schema. Each connector 24 partitions the event data into clusters (step 64). Each cluster is then divided into chunks (step 66). Meta data is assembled and included in or otherwise linked to each chunk (step 68). The metadata, as noted, for a given chunk identifies that chunk and may also identify contents of that chunk—the contents being information related to a given event attribute type.

Storage manager 26 collects the chunks from connectors 24 (step 70). Storage manage 26 may merge the collected chunks (step 72) and then write the chunks to a data file (step 74). Data store uses the metadata collected in step 70 to maintain an index for the data file to which the chunks were written (step 76). Upon receiving a query from client 18 (step 78), storage manager 26 uses the index to identify a chunk or chunks that satisfy the query (step 80). Storage manager 6 returns the identified chunks or contents thereof to client (step 82).

### Conclusion

FIGS. 1-3 depict the architecture, functionality, and operation of various embodiments. In particular, FIGS. 2-3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical, non-transitory media such as, for example, electronic, magnetic, optical, electromagnetic, or semiconductor media. More specific examples of suitable computer-readable media include, but are not limited to, a portable magnetic computer diskette such as floppy diskettes, hard drives, solid state drives, random access memory (RAM), read-only memory (ROM), erasable programmable read-only memory, flash drives, and portable compact discs.

Although the flow diagram of FIG. 4 and the communication sequence diagram of FIG. 5 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A distributed event processing method, comprising:
providing a plurality of connectors each connector configured to acquire event data from an assigned data source, partition acquired event data into clusters, and divide each duster into chunks,
collecting the chunks from the plurality of connectors; and
storing the chunks to a data file that can be queried.

2. The method of claim 1, wherein providing comprises providing a plurality of connectors, each connector configured to:
partition by partitioning the acquired event data into clusters, each cluster including rows of event data segmented into columns of event fields;
divide by dividing each cluster into chunks where each chunk includes the event fields of a particular column of that cluster.

3. The method of claim 2, wherein providing comprises providing a plurality of connectors, each connector configured to divide by dividing each cluster into compressed chunks.

4. The method of claim 2, wherein:
providing comprises providing a plurality of connectors, each connector configured to divide each cluster into chunks wherein each chunk is associated with metadata identifying that chunk and an attribute of the chunk, the associated metadata included in or otherwise linked to its corresponding chunk; and
collecting comprises collecting the chunks and associated metadata from the plurality of connectors.

5. The method of claim 4 wherein storing comprises merging the collected chunks and storing the merged chunks to the data file and maintaining an index for the data file from the collected metadata.

6. A non-transitory computer readable medium including instructions that when executed cause a processor to:
collect chunks from a plurality of connectors each configured to acquire event data from an assigned data source, partition acquired event data into clusters, and divide each cluster into chunks, and
store the chunks to a data file that can be queried.

7. The medium of claim 6, wherein each cluster partitioned by the plurality of connectors includes rows of event data divided into columns of event fields, and wherein the instructions, when executed, cause a processor to collect chunks from the plurality of connectors, wherein each collected chunk includes the event fields of a particular column of the cluster from which it was divided.

8. The medium of claim 7, wherein each chunk is associated with metadata identifying that chunk and an attribute of the chunk, the associated metadata included in or otherwise linked to that chunk, and wherein the instructions, when executed, cause the processor to collect the chunks and associated metadata from the plurality of connectors.

9. The medium of claim 8 wherein the instructions, when executed, cause the processor to:
merge the collected chunks;
store the merged chunks to the data file;
maintain an index for the data file utilizing the collected metadata.

10. The medium of claim 9, wherein the instructions, when executed, cause the processor to examine the index to identify chunks in the data file that are relevant to a query.

11. A distributed event processing system, comprising a plurality of connectors and a storage manager, wherein:
each connector is configured to acquire event data from an assigned data source, partition acquired event data into clusters, and divide each cluster into chunks, and
the storage manager is configured to collect the chunks from the plurality of connectors and store the collected chunks to a data file that can be queried.

12. The system of claim 11, wherein each cluster can be represented by a table having a plurality of rows each representing an event and including a plurality of event fields, each connector being configured to divide by dividing each cluster into chunks where each chunk includes the event fields defining a particular column of that cluster.

13. The system of claim 12 wherein each connector configured to divide each cluster into chunks such that each chunk is associated with metadata identifying that chunk and an attribute of the chunk, the associated metadata included in or otherwise linked to its corresponding chunk; and
The storage manager is configured to collecting the chunks and associated metadata from the plurality of connectors.

14. The system of claim 13 wherein the storage manager is configured to:
merging the collected chunks;
store the merged chunks to the data file; and
maintain an index for the data file from the collected metadata.

15. The system of claim 14, wherein the storage manager is configured to examine the index to identify chunks in the data file that are relevant to a query and to return the identified chunks or data included in the identified chunks in response to the query.
